(19) United States
(12) Patent Application Publication
(10) Pub. No.: US 2023/0375887 A1
(43) Pub. Date: Nov. 23, 2023

(54) LIGHT ADJUSTMENT DEVICE

(71) Applicant: Japan Display Inc., Tokyo (JP)

(72) Inventors: Takahiro OCHIAI, Tokyo (JP); Yukiya HIRABAYASHI, Tokyo (JP); Shunpei TAKEUCHI, Tokyo (JP); Osamu KOBAYASHI, Tokyo (JP); Takeo KOITO, Tokyo (JP); Koichi NAGAO, Tokyo (JP)

(21) Appl. No.: 18/230,257

(22) Filed: Aug. 4, 2023

Related U.S. Application Data
(63) Continuation of application No. PCT/JP2021/045509, filed on Dec. 10, 2021.

(30) Foreign Application Priority Data
Feb. 25, 2021 (JP) 2021-029044

(51) Int. Cl. G02F 1/1345; G02F 1/139; G02F 1/1343

(52) U.S. Cl. CPC G02F 1/1345; G02F 1/1393; G02F 1/134309

(57) ABSTRACT

A light adjustment device in which a plurality of liquid crystal cells each including a light adjustment region configured to polarize light emitted from a light source are stacked in a direction in which the light is emitted is disclosed. The liquid crystal cells each include a first substrate including a plurality of first drive electrodes extending in a first direction in the light adjustment region, and a second substrate sandwiching a liquid crystal layer between the first substrate and the second substrate and including a plurality of second drive electrodes extending in a second direction different from the first direction in the light adjustment region.

### CROSS-REFERENCE TO RELATED APPLICATION

This application is a continuation of International Patent Application No. PCT/JP2021/045509 filed on Dec. 10, 2021 which designates the United States, incorporated herein by reference, and which claims the benefit of priority from Japanese Patent Application No. 2021-029044 filed on Feb. 25, 2021, incorporated herein by reference.

### BACKGROUND

### 1. Technical Field

The present invention relates to a light adjustment device.

### 2. Description of the Related Art

In a conventional illumination instrument, a light source such as an LED is combined with a thin lens provided with a prism pattern, and the distance between the light source and the thin lens is changed to change a light distribution angle. In such an illumination instrument, a small-sized motor is used to drive the thin lens to change the distance between the light source and the thin lens. For example, in a disclosed illumination instrument, the front of a transparent light bulb is covered by a liquid crystal light adjustment element, and the transmittance of a liquid crystal layer is changed to switch directly reaching light and scattering light (refer to Japanese Patent Application Laid-open Publication No. H2-65001, for example).

In a configuration including a liquid crystal cell, drive electrodes are provided on two substrates sandwiching a liquid crystal layer, and the orientation of liquid crystal molecules is controlled by applying drive voltage between the electrodes provided on the two substrates. A terminal for applying drive voltage to the electrodes is provided on at least one of the two substrates. In a process of manufacturing the liquid crystal cell, when short-circuit occurs between the electrodes on the two substrates or between wires for supplying drive voltage to the electrodes, a light adjustment function is lost and the yield rate decreases. Thus, improvement of the yield rate in manufacturing of the liquid crystal cell has been desired.

An object of the present invention is to provide a light adjustment device with which it is possible to improve the yield rate in manufacturing of a liquid crystal cell.

### SUMMARY

A light adjustment device according to an embodiment in which a plurality of liquid crystal cells each including a light adjustment region configured to polarize light emitted from a light source are stacked in a direction in which the light is emitted is disclosed. The liquid crystal cells each include a first substrate including a plurality of first drive electrodes extending in a first direction in the light adjustment region, and a second substrate sandwiching a liquid crystal layer between the first substrate and the second substrate and including a plurality of second drive electrodes extending in a second direction different from the first direction in the light adjustment region, and the first substrate includes a plurality of first metal wires configured to supply drive voltage to the respective first drive electrodes, a plurality of second metal wires configured to supply drive voltage to the respective second drive electrodes through conduction parts provided between the second metal wires and the second substrate, a plurality of coupling terminals configured to supply drive voltage to the respective first metal wires and the respective second metal wires, and a plurality of examination terminals having footprints larger than footprints of the coupling terminals and provided for the respective first metal wires and the respective second metal wires.

### BRIEF DESCRIPTION OF THE DRAWINGS

FIG. 1 is a perspective view illustrating an example of an illumination instrument in which a light adjustment device according to an embodiment is provided;

FIG. 2 is a schematic plan view of a first substrate when viewed in a Dz direction;

FIG. 3 is a schematic plan view of a second substrate when viewed in the Dz direction;

FIG. 4 is a perspective diagram of a liquid crystal cell in which the first substrate and the second substrate are placed over in the Dz direction;

FIG. 5 is a sectional view along line A-A′ illustrated in FIG. 4;

FIG. 6A is a diagram illustrating the rubbing direction of an alignment film of the first substrate;

FIG. 6B is a diagram illustrating the rubbing direction of an alignment film of the second substrate;

FIG. 7 is a perspective diagram of a liquid crystal cell in which a first substrate and a second substrate of the light adjustment device according to the embodiment are placed over in the Dz direction;

FIG. 8A is a schematic diagram of a sectional structure of a coupling terminal;

FIG. 8B is a schematic diagram of a sectional structure of an examination terminal;

FIG. 9 is a perspective diagram of a liquid crystal cell in which a first substrate and a second substrate of a light adjustment device according to a first modification of the embodiment are placed over in the Dz direction;

FIG. 10 is a perspective diagram of a liquid crystal cell in which a first substrate and a second substrate of a light adjustment device according to a second modification of the embodiment are placed over in the Dz direction;

FIG. 11 is a schematic diagram of a sectional structure of a jumper part; and

FIG. 12 is a perspective diagram of a liquid crystal cell in which a first substrate and a second substrate of a light adjustment device according to a third modification of the embodiment are placed over in the Dz direction.

### DETAILED DESCRIPTION

Aspects (embodiments) of the invention will be described below in detail with reference to the accompanying drawings. Contents described below in the embodiments do not limit the present invention. Components described below include those that could be easily thought of by the skilled person in the art and those identical in effect. Components described below may be combined as appropriate. What is disclosed herein is merely exemplary, and any modification that could be easily thought of by the skilled person in the art as appropriate without departing from the gist of the invention is contained in the scope of the present invention. For clearer description, the drawings are schematically illustrated for the width, thickness, shape, and the like of each component as compared to an actual aspect in some cases, but the drawings are merely exemplary and do not limit interpretation of the present invention. In the present specification and drawings, any element same as that already described with reference to an already described drawing is denoted by the same reference sign, and detailed description thereof is omitted as appropriate in some cases.

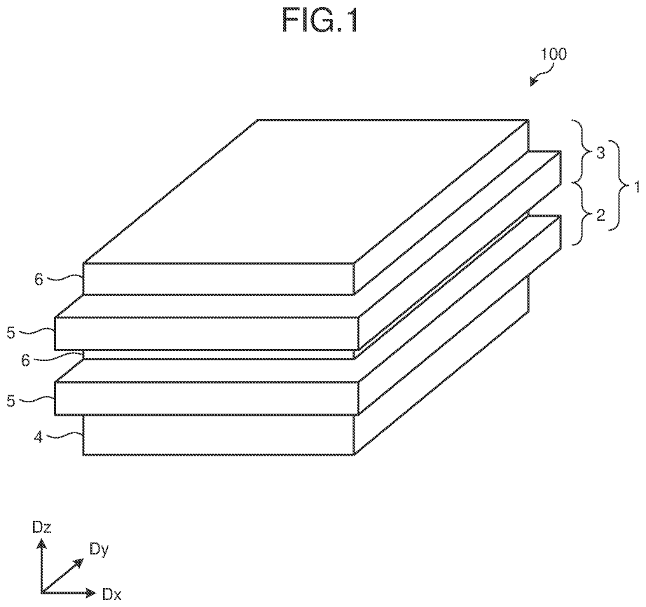

FIG. 1 is a perspective view illustrating an example of an illumination instrument in which a light adjustment device according to an embodiment is provided. First, a light adjustment device 1 according to the embodiment will be schematically described below.

As illustrated in FIG. 1, the light adjustment device 1 of the present embodiment includes a first liquid crystal cell 2 and a second liquid crystal cell 3.

An illumination instrument 100 includes the light adjustment device 1 and a light source 4. The light source 4 emits light toward the light adjustment device 1. The light source 4 is configured as, for example, a light emitting diode (LED).

In FIG. 1, a direction on a plane of the light adjustment device 1 is defined as a Dx direction, and a direction orthogonal to the Dx direction on the plane of the light adjustment device 1 is defined as a Dy direction. A direction orthogonal to the Dx-Dy plane is defined as a Dz direction.

The Dz direction indicates the emission direction of light from the light source 4. The illumination instrument 100 has a configuration in which the first liquid crystal cell 2 and the second liquid crystal cell 3 are stacked in the Dz direction. Hereinafter, a side where a radiation surface (or upper surface) through which light is radiated from the light adjustment device 1 in the Dz direction is positioned is also referred to as a radiation surface side (or upper surface side), and a side where a back surface (or lower surface) opposite the radiation surface (or upper surface) in the Dz direction is positioned is also referred to as an entrance surface side (or lower surface side).

An alignment film 18 and an alignment film 19 have rubbing directions different from each other as described later. The first liquid crystal cell 2 and the second liquid crystal cell 3 have the same configuration. In the present embodiment, the first liquid crystal cell 2 is a liquid crystal cell for p-wave polarized light. The second liquid crystal cell 3 is a liquid crystal cell for s-wave polarized light. Accordingly, flexible light adjustment control is possible. Note that the first liquid crystal cell 2 may be a liquid crystal cell for s-wave polarized light, and the second liquid crystal cell 3 may be a liquid crystal cell for p-wave polarized light. It suffices that one of the first liquid crystal cell 2 and the second liquid crystal cell 3 is a liquid crystal cell for p-wave polarized light and the other is a liquid crystal cell for s-wave polarized light.

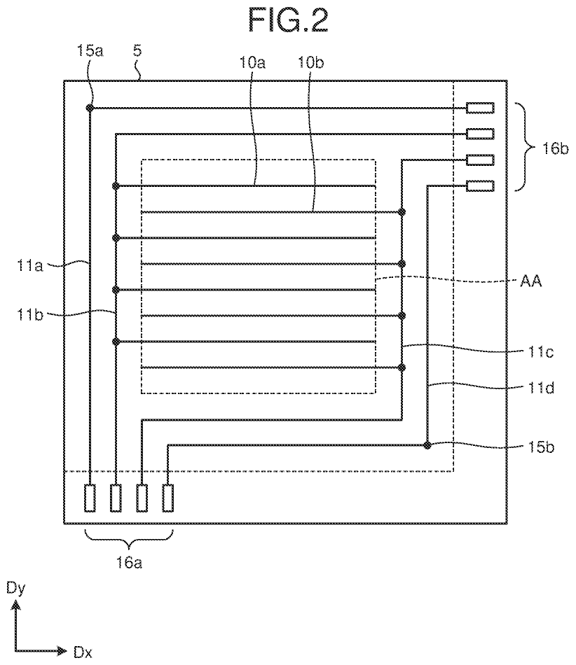

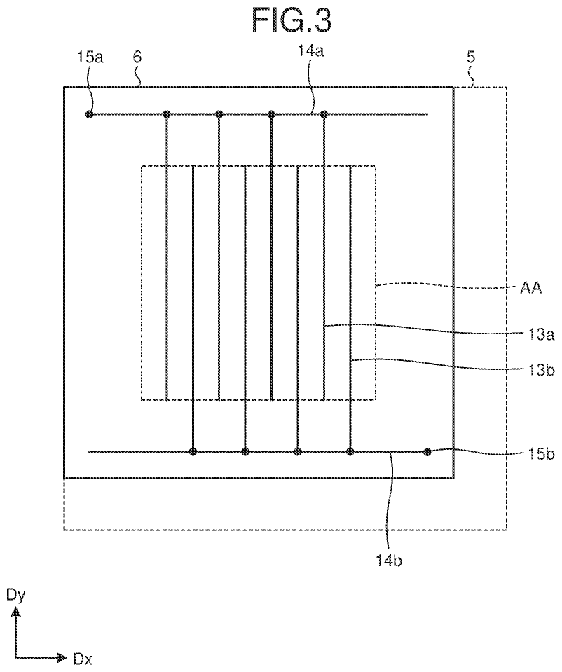

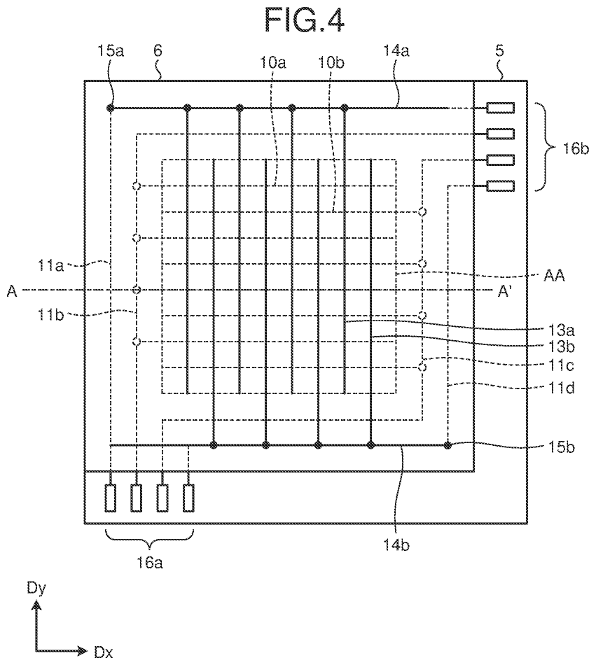

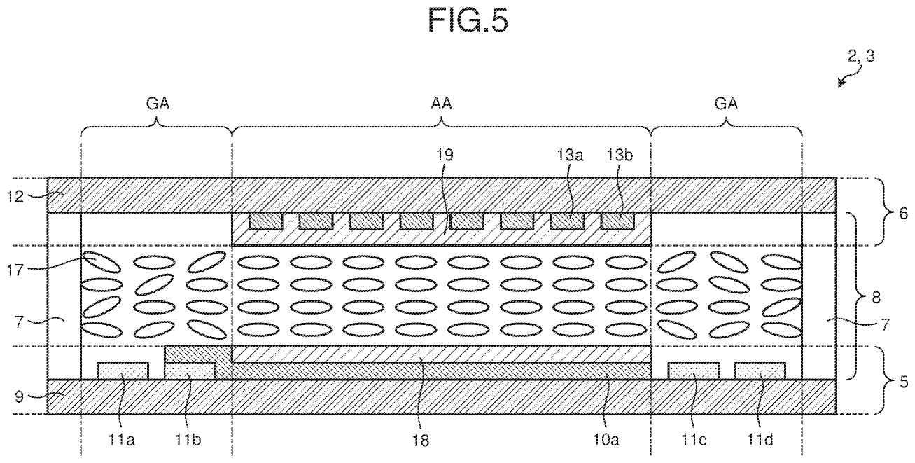

The first liquid crystal cell 2 and the second liquid crystal cell 3 each include a first substrate 5 and a second substrate 6. FIG. 2 is a schematic plan view of the first substrate when viewed in the Dz direction. FIG. 3 is a schematic plan view of the second substrate when viewed in the Dz direction. FIG. 4 is a perspective diagram of a liquid crystal cell in which the first substrate and the second substrate are placed over in the Dz direction. FIG. 5 is a sectional view along line A-A′ illustrated in FIG. 4.

As illustrated in FIG. 5, the first liquid crystal cell 2 and the second liquid crystal cell 3 each include a liquid crystal layer 8 between the first substrate 5 and the second substrate 6, the liquid crystal layer 8 being circumferentially sealed by a sealing member 7.

The liquid crystal layer 8 modulates light passing through the liquid crystal layer 8 in accordance with the state of an electric field. The liquid crystal layer 8 may be a horizontal electric field mode such as fringe field switching (FFS) as a form of in-plane switching (IPS) or may be a vertical electric field mode. For example, liquid crystals of various modes such as twisted nematic (TN), vertical alignment (VA), and electrically controlled birefringence (ECB) may be used and are not limited by the kind and configuration of the liquid crystal layer 8.

As illustrated in FIG. 2, a plurality of first drive electrodes 10a and 10b, a plurality of first metal wires 11b and 11c that supply drive voltage applied to the first drive electrodes 10a and 10b, and a plurality of second metal wires 11a and 11d that supply drive voltage applied to a plurality of second drive electrodes 13a and 13b (refer to FIG. 3) provided on the second substrate 6 to be described later are provided on the liquid crystal layer 8 side of a base material 9 of the first substrate 5 illustrated in FIG. 5. The first metal wires 11b and 11c and the second metal wires 11a and 11d are provided in a wiring layer of the first substrate 5. As illustrated in FIG. 2, the first drive electrodes 10a and 10b on the first substrate 5 extend in the Dx direction (first direction).

As illustrated in FIG. 3, the second drive electrodes 13a and 13b and a plurality of metal wires 14a and 14b that supply drive voltage applied to the drive electrodes 13 are provided on the liquid crystal layer 8 side of a base material 12 of the second substrate 6 illustrated in FIG. 5. The metal wires 14a and 14b are provided in a wiring layer of the second substrate 6. As illustrated in FIG. 3, the second drive electrodes 13a and 13b on the second substrate 6 extend in the Dy direction (second direction).

The first drive electrodes 10a and 10b and the second drive electrodes 13a and 13b are translucent electrodes formed of a translucent conductive material (translucent conductive oxide) such as indium tin oxide (ITO). The first substrate 5 and the second substrate 6 are translucent substrates such as glass or resin. The metal wires 11 and the metal wires 14 are formed of at least one metallic material such as aluminum (Al), copper (Cu), silver (Ag), molybdenum (Mo), or an alloy thereof. The metal wires 11 and the metal wires 14 may be multilayered bodies of a plurality of stacked layers using one or more of these metallic materials. At least one metallic material such as aluminum (Al), copper (Cu), silver (Ag), molybdenum (Mo), or an alloy thereof has a lower resistance than translucent conductive oxide such as ITO.

The second metal wire 11a of the first substrate 5 and the metal wire 14a of the second substrate 6 are coupled to each other through a conduction part 15a such as a via. The second metal wire 11d of the first substrate 5 and the metal wire 14b of the second substrate 6 are coupled to each other through a conduction part 15b such as a via.

Coupling (flex-on-board) terminal parts 16a and 16b that are coupled to non-illustrated flexible printed circuits (FPCs) are provided in regions on the first substrate 5, the regions not overlapping the second substrate 6 in the Dz direction. The coupling terminal parts 16a and 16b each include four coupling terminals corresponding to the first metal wires 11b and 11c and the second metal wires 11a and 11d, respectively.

The coupling terminal parts 16a and 16b are provided in the wiring layer of the first substrate 5. Drive voltage to be applied to the first drive electrodes 10a and 10b on the first substrate 5 and the second drive electrodes 13a and 13b on the second substrate 6 is supplied to the first liquid crystal cell 2 and the second liquid crystal cell 3 from an FPC coupled to the coupling terminal part 16a or 16b. Only one of the coupling terminal parts 16a and 16b may be provided. Hereinafter, the coupling terminal parts 16a and 16b are also simply referred to as “coupling terminal parts 16”.

As illustrated in FIG. 4, in the first liquid crystal cell 2 and the second liquid crystal cell 3, the first substrate 5 and the second substrate 6 overlap each other in the Dz direction (light emission direction), and the first drive electrodes 10a and 10b on the first substrate 5 intersect the second drive electrodes 13a and 13b on the second substrate 6 when viewed in the Dz direction. In the first liquid crystal cell 2 and the second liquid crystal cell 3 thus configured, the orientation of liquid crystal molecules 17 in the liquid crystal layer 8 can be controlled by supplying drive voltage to the first drive electrodes 10a and 10b on the first substrate 5 and the second drive electrodes 13a and 13b on the second substrate 6. A region in which the orientation of the liquid crystal molecules 17 in the liquid crystal layer 8 can be controlled is referred to as a “light adjustment region AA”. Light transmitting through the light adjustment region AA of the first liquid crystal cell 2 and the second liquid crystal cell 3 can be controlled by changing refractive index distribution of the liquid crystal layer 8 in the light adjustment region AA. A region in which the liquid crystal layer 8 is sealed by the sealing member 7 outside a light adjustment region 200 is referred to as a “peripheral region GA” (refer to FIG. 5).

As illustrated in FIG. 5, in the light adjustment region of the first substrate 5, the first drive electrodes 10a and 10b (FIG. 5, the first drive electrode 10a) are covered by the alignment film 18. In the light adjustment region of the second substrate 6, the second drive electrodes 13a and 13b are covered by the alignment film 19. As described above, the alignment films 18 and 19 have rubbing directions different from each other.

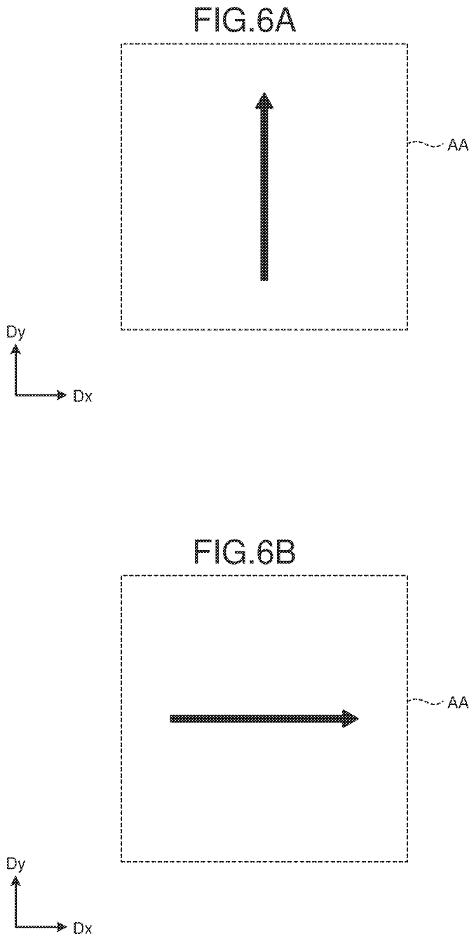

FIG. 6A is a diagram illustrating the rubbing direction of the alignment film of the first substrate. FIG. 6B is a diagram illustrating the rubbing direction of the alignment film of the second substrate.

As illustrated in FIGS. 6A and 6B, the rubbing direction of the alignment film 18 of the first substrate and the rubbing direction of the alignment film 19 of the second substrate intersect each other in plan view. Specifically, the rubbing direction of the alignment film 18 of the first substrate 5 illustrated in FIG. 6A is orthogonal to the direction in which the first drive electrodes 10a and 10b extend. The rubbing direction of the alignment film 19 of the second substrate 6 illustrated in FIG. 6B is orthogonal to the direction in which the second drive electrodes 13a and 13b extend.

In the example illustrated in FIG. 2, the coupling terminal parts 16a and 16b in different orientations are provided in a region extending in the Dx direction and a region extending in the Dy direction, respectively, on the first substrate 5 in which the first substrate 5 and the second substrate 6 do not overlap each other in the Dz direction. Accordingly, FPCs can be coupled to the first liquid crystal cell 2 and the second liquid crystal cell 3 in different directions, which improves operability.

The illumination instrument 100 can be downsized when used with the light adjustment device 1 according to the present embodiment described above in the structure illustrated in FIG. 1.

Although the present embodiment describes the configuration in which one first liquid crystal cell 2 for p-wave polarized light and one second liquid crystal cell 3 for s-wave polarized light are stacked, the present invention is not limited to the configuration, and for example, a plurality of combinations of stacked first liquid crystal cell 2 and second liquid crystal cell 3 may be provided. For example, two combinations of stacked first liquid crystal cell 2 and second liquid crystal cell 3 may be provided, in other words, two liquid crystal cells for p-wave polarized light and two liquid crystal cells for s-wave polarized light may be provided so that light adjustment control can be more flexibly performed.

In a process of manufacturing the first liquid crystal cell 2 and the second liquid crystal cell 3, when short-circuit occurs between the first drive electrodes 10a and 10b, between the first metal wires 11b and 11c, and between the second metal wires 11a and 11d on the first substrate 5 and between the second drive electrodes 13a and 13b and between the metal wires 14a and 14b on the second substrate 6, a light adjustment function of the light adjustment device 1 in which the first liquid crystal cell 2 and the second liquid crystal cell 3 are stacked is lost, and the yield rate decreases. Thus, improvement of the yield rate in manufacturing has been desired.

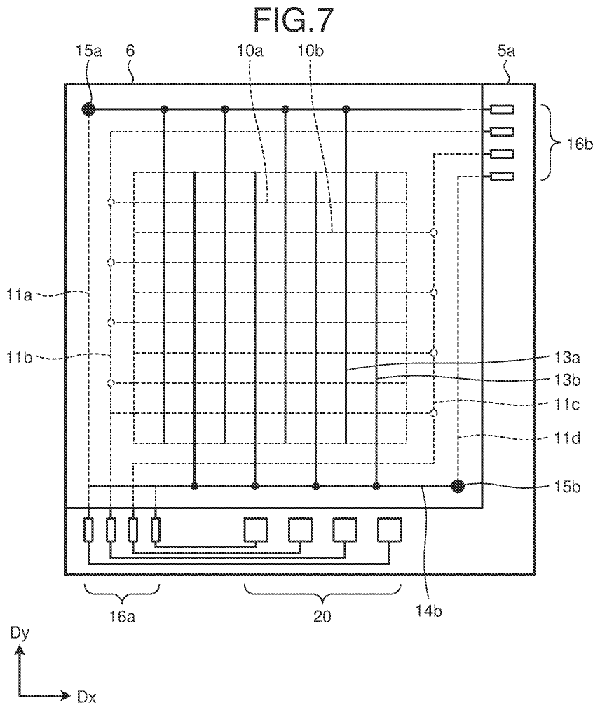

FIG. 7 is a perspective diagram of a liquid crystal cell in which a first substrate and a second substrate of the light adjustment device according to the embodiment are placed over in the Dz direction.

In the example illustrated in FIG. 7, in addition to the coupling terminal parts 16a and 16b, an examination terminal part 20 that is used when short-circuit examination is performed in the manufacturing process is provided on a first substrate 5a constituting the first liquid crystal cell 2 and the second liquid crystal cell 3. The examination terminal part 20 includes four examination terminals corresponding to the first metal wires 11b and 11c and the second metal wires 11a and 11d, respectively, and is provided in the wiring layer of the first substrate 5.

The footprint of each coupling terminal of the coupling terminal parts 16a and 16b is determined depending on an FPC to be coupled. Typically, an FPC has a small pitch, and it is difficult to stably couple a short-circuit examination jig (not illustrated).

As illustrated in FIG. 7, the footprints of the examination terminals of the examination terminal part 20 is larger than the footprints of the coupling terminals of the coupling terminal parts 16a and 16b, and thus it is possible to stably couple a short-circuit examination jig.

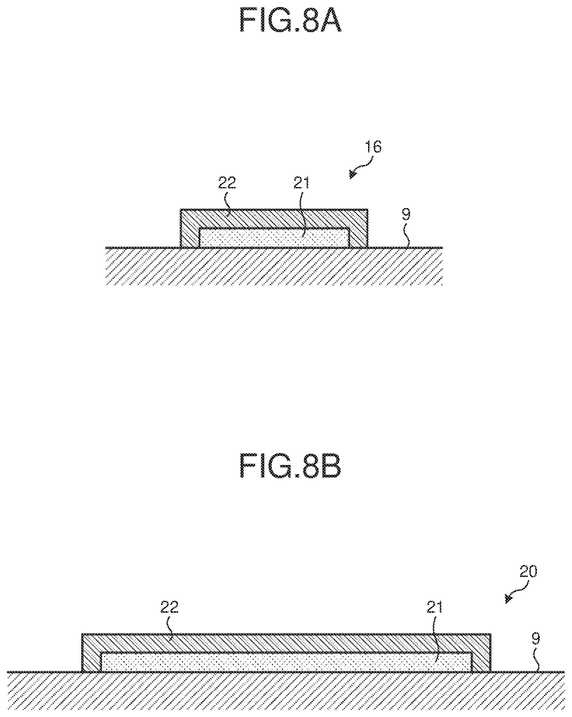

FIG. 8A is a schematic diagram of a sectional structure of each coupling terminal. FIG. 8B is a schematic diagram of a sectional structure of each examination terminal.

As illustrated in FIGS. 8A and 8B, in each coupling terminal of the coupling terminal parts 16a and 16b and each examination terminal of the examination terminal part 20, for example, a metallic material 21 provided in the wiring layer of the first substrate 5 is covered by a corrosive-resistant translucent conductive material 22 such as ITO like the drive electrodes 10. Accordingly, the resistance of contact with an FPC and a probe of a short-circuit examination jig can be reduced, and stable coupling is possible. Note that the metallic material 21 constituting each coupling terminal of the coupling terminal parts 16a and 16b and each examination terminal of the examination terminal part 20 is formed in the same process as the first metal wires 11b and 11c and the second metal wires 11a and 11d in a process of manufacturing the first substrate 5. The translucent conductive material 22 constituting each coupling terminal of the coupling terminal parts 16a and 16b and each examination terminal of the examination terminal part 20 is formed in the same process as the first drive electrodes 10a and 10b in the process of manufacturing the first substrate 5.

### FIRST MODIFICATION

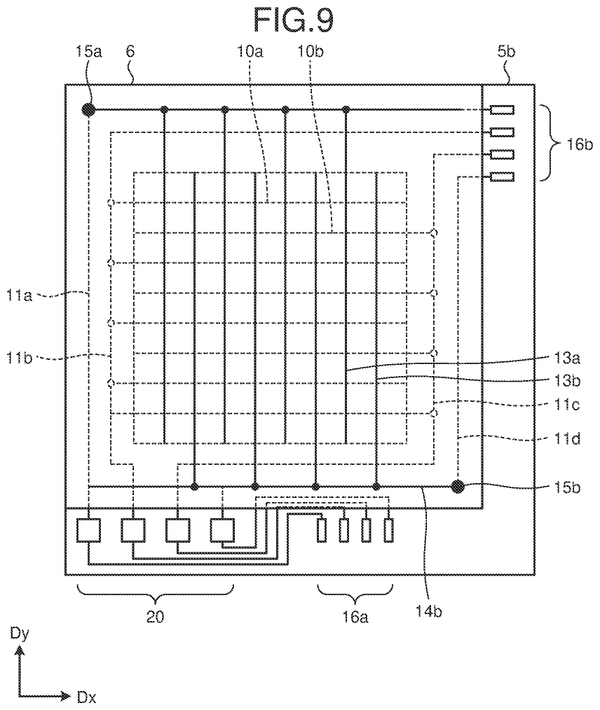

FIG. 9 is a perspective diagram of a liquid crystal cell in which a first substrate and a second substrate of a light adjustment device according to a first modification of the embodiment are placed over in the Dz direction.

In a first substrate 5b illustrated in FIG. 9, disposition of the coupling terminal part 16a and disposition of the examination terminal part 20 are interchanged as compared to the example illustrated in FIG. 7.

Accordingly, for example, when the first substrate 5a illustrated in FIG. 7 is used for the first liquid crystal cell 2 and the first substrate 5b illustrated in FIG. 9 is used for the second liquid crystal cell 3, FPCs of the first liquid crystal cell 2 and the second liquid crystal cell 3 do not overlap in the Dy direction, which can improve operability in a process of manufacturing the light adjustment device 1.

### SECOND MODIFICATION

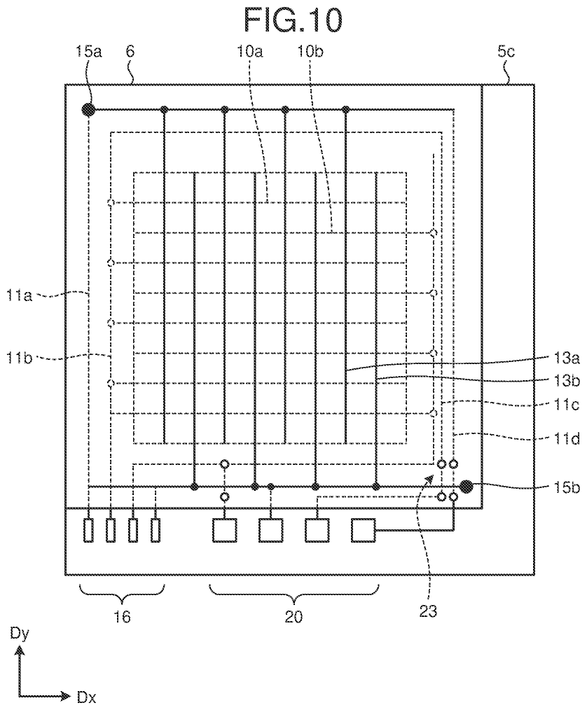

FIG. 10 is a perspective diagram of a liquid crystal cell in which a first substrate and a second substrate of a light adjustment device according to a second modification of the embodiment are placed over in the Dz direction.

In a first substrate 5c illustrated in FIG. 10, a wiring path to the examination terminal part 20 is changed as compared to the example illustrated in FIG. 7. In FIG. 10, a jumper part 23 needs to be provided at a part intersecting the second metal wire 11d.

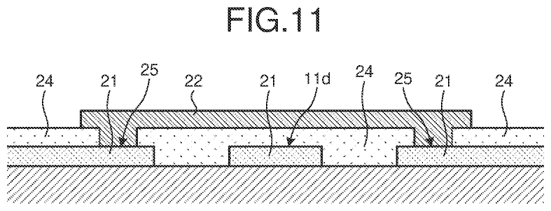

FIG. 11 is a schematic diagram of a sectional structure of the jumper part. At the jumper part 23 illustrated in FIG. 11, the second metal wire 11d provided in the wiring layer of the first substrate 5 is covered by an insulating layer 24, and coupling is provided by the translucent conductive material 22 over the insulating layer 24.

Note that, to achieve the structure illustrated in FIG. 11, the insulating layer 24 needs to be provided on the wiring layer including the first metal wires 11c and 11b, the second metal wires 11a and 11d, the coupling terminals of the coupling terminal parts 16, and the examination terminals of the examination terminal part 20 in a substrate manufacturing process. Since the insulating layer 24 has a refractive index different from those of the base materials and the translucent conductive material 22, the insulating layer 24 is desirably not provided in the light adjustment region AA. Accordingly, it is possible to prevent transmittance decrease in the light adjustment region AA due to occurrence of interface reflection. In the example illustrated in FIG. 11, a contact hole 25 is provided in the insulating layer 24, and the metallic material 21 of the wiring layer and the translucent conductive material 22 are electrically coupled for conduction through the contact hole 25, which forms the jumper part 23.

### THIRD MODIFICATION

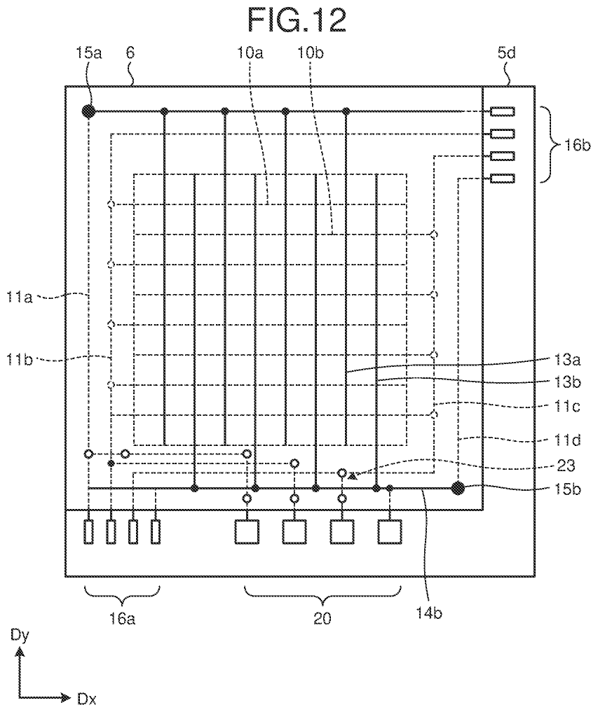

FIG. 12 is a perspective diagram of a liquid crystal cell in which a first substrate and a second substrate of a light adjustment device according to a third modification of the embodiment are placed over in the Dz direction.

In a first substrate 5d illustrated in FIG. 12, wiring path to the examination terminal part 20 is changed as compared to the example illustrated in FIG. 10. Accordingly, the position of the jumper part 23 is different from that in the example illustrated in FIG. 10. In the third modification illustrated in FIG. 12, the coupling terminal part 16b is provided in addition to the coupling terminal part 16a.

Note that, in the example described above in the embodiment, the examination terminal part 20 is provided on the first substrate of the first liquid crystal cell 2 and the second liquid crystal cell 3, but the present invention is not limited thereto, and the examination terminal part 20 may be provided on the second substrate of the first liquid crystal cell 2 and the second liquid crystal cell 3. Alternatively, the examination terminal part 20 may be provided on both the first substrate and the second substrate of the first liquid crystal cell 2 and the second liquid crystal cell 3.

In the example described above in the embodiment, the coupling terminal parts 16 (16a and 16b) are provided on the first substrate of the first liquid crystal cell 2 and the second liquid crystal cell 3, but the present invention is not limited thereto, and the coupling terminal parts 16 (16a and 16b) may be provided on the second substrate of the first liquid crystal cell 2 and the second liquid crystal cell 3. Alternatively, the coupling terminal parts 16 (16a and 16b) may be provided on both the first substrate and the second substrate of the first liquid crystal cell 2 and the second liquid crystal cell 3.

According to the above-described configuration of the embodiment, the examination terminal part 20 having a footprint larger than that of each coupling terminal part 16 (16a or 16b) for coupling with an FPC is provided. Accordingly, it is possible to stably couple a short-circuit examination jig, thereby improving the yield rate in manufacturing of a liquid crystal cell.

Preferable embodiments of the present disclosure are described above, but the present disclosure is not limited to such embodiments. Contents disclosed in the embodiments are merely exemplary, and various kinds of modifications are possible without departing from the scope of the present disclosure. Any modification performed as appropriate without departing from the scope of the present disclosure belongs to the technical scope of the present disclosure.

What is claimed is:

1. A light adjustment device in which a plurality of liquid crystal cells each including a light adjustment region configured to polarize light emitted from a light source are stacked in a direction in which the light is emitted, wherein
the liquid crystal cells each include
a first substrate including a plurality of first drive electrodes extending in a first direction in the light adjustment region, and
a second substrate sandwiching a liquid crystal layer between the first substrate and the second substrate and including a plurality of second drive electrodes extending in a second direction different from the first direction in the light adjustment region, and
the first substrate includes
a plurality of first metal wires configured to supply drive voltage to the respective first drive electrodes,
a plurality of second metal wires configured to supply drive voltage to the respective second drive electrodes through conduction parts provided between the second metal wires and the second substrate,
a plurality of coupling terminals configured to supply drive voltage to the respective first metal wires and the respective second metal wires, and
a plurality of examination terminals having footprints larger than footprints of the coupling terminals and provided for the respective first metal wires and the respective second metal wires.

2. The light adjustment device according to claim 1, comprising a plurality of combinations of stacked liquid crystal cell for p-wave polarized light and liquid crystal cell for s-wave polarized light.

3. The light adjustment device according to claim 1, wherein the examination terminals are each a metallic material provided on a wiring layer of the first substrate and covered by a translucent conductive material.

4. The light adjustment device according to claim 3, wherein an insulating layer covering the wiring layer of the first substrate is provided in a region except for the light adjustment region, and the metallic material and the translucent conductive material are electrically coupled to each other through a contact hole provided in the insulating layer.
